(19) United States
(12) Patent Application Publication
(10) Pub. No.: US 2008/0112992 A1
(43) Pub. Date: May 15, 2008

(54) METHOD FOR CONTROLLING THE APPLICATION OF AN INSECTICIDE AND COMPOSITION THEREOF

(75) Inventors: Hisham Mohamed Mahgoub, Al Sayeda Zaynab (EG); Amina Ahmed Mahmoud Fahmy, Garden City (EG)

Correspondence Address: SNELL & WILMER L.L.P. (Main), 400 EAST VAN BUREN, ONE ARIZONA CENTER, PHOENIX, AZ, 85004-2202, US

(73) Assignee: FLIT.S.A., Geneva (CH)

(21) Appl. No.: 11/851,192

(22) Filed: Sep. 6, 2007

Related U.S. Application Data
(62) Division of application No. 10/481,388, filed on Dec. 19, 2003.

(30) Foreign Application Priority Data
Jun. 20, 2001 (EG) 01114940.8

(51) Int. Cl. A01N 65/00; A01N 37/08; A01N 37/34; A01N 59/14

(52) U.S. Cl. 424/405; 514/65; 514/521; 514/530; 514/122; 424/659

(57) ABSTRACT

The invention relates to a method for controlling the application of an insecticide on a surface, which comprises the use of an insecticide composition including a pH indicator colorant in an aqueous medium changing the colorless after drying in the air on said surface, and the recoloration of the insecticide composition by remoistering selected areas of the surface to be checked.

### CROSS-REFERENCE TO RELATED APPLICATION

This application is a divisional application of U.S. patent application Ser. No. 10/481,388, and entitled “Method For Controlling the Application of an Insecticide and Composition Therefore”, filed on Dec. 19, 2003, currently pending.

### DESCRIPTION

The present invention relates to a method for controlling the application of an insecticide or pesticide on a surface, as well as to an insecticide or pesticide composition, which is appropriate for implementing this method.

The use of insecticide products in the home is necessary for the elimination and control of such damaging pests as cockroaches, ants, silverfish, etc. However, there is a concern that such products should not be applied in places where they could come in contact with humans or pets.

A common method of application is the aerosol, whereby a spray or mist is dispensed from a pressurised container. However, it is typical of these products that the spray cannot be easily controlled, and thus there is overspray which can go onto areas where the insecticide should not be. Further, since the liquid on the surface cannot be easily observed, it is very difficult to determine if the right amount of material is being applied. Too little product will be ineffective, and too much products are both wasteful and potentially harmful to the environment.

The purpose of this invention is to provide a method for controlling insect pests by the application of an insecticide product that is applied to surfaces commonly travelled by insect pests, and that the insecticide, when applied, is coloured, but after a certain period of time, the colour fades so that the presence of the insecticide is unobtrusive.

The advantage for the user is that the colour provides a visual guide to easily show where the product has been applied, thus enabling the user to control both the amount and placement of the insecticide. After application, the insecticide colour fades, and thus its presence becomes unobtrusive. Overspray is clearly revealed and the product may be cleaned from those areas where it is not intended.

If necessary, the insecticide applied can be revealed again, by simply remoistening the surfaces concerned, for example by spraying water thereon.

More particularly, a first object of the present invention is a method for controlling the application of an insecticide on a surface, which comprises the use of an insecticide composition including a pH indicator colorant in an aqueous medium changing to colourless after drying in the air on said surface, and the recoloration of the insecticide composition by remoistering selected areas of the surface to be checked.

A second object of the invention is an insecticide composition, which can be used to implement the above method, and which comprises at least one insect killing agent in aqueous solution, a coloured pH indicator which becomes colourless upon exposure to air and at least a compound for adjusting the pH of the composition to a pH at which the pH indicator is coloured.

As appropriate pH indicator, it can be mentioned for example 4-nitrophenol and phenolphthalein, and possibly 3-nitrophenol and thymolphthalein.

The 4-nitrophehol gives a yellow colour to the composition at a pH of about 7.0 and higher, whereas phenolphthalein necessitates a high pH value of at least 9.0 to be coloured (pink-red).

The level of the pH indicator is generally of 0.01 to 1.0 wt %, preferably of 0.05 to 0.5 wt %, so that the level is not too high resulting in a colour change time which is too long and may cause staining, and not too low resulting in an insufficiently intense colour.

The water content is comprised between about 25 and 85 wt %, depending on the presence or not of a propellant.

As insect killing agents, the known ones can be used, for example n-pyrethrins, malathion, boric acid, tetramethrin, esbiothrin, Etoc, neopynamineforte, deltamethrin, propoxuur, cypermethrin, Gokilaht S, etc. Each of these agents is generally used at a level of 0.01 to 1.0 wt % according to their respective solubility and toxicity.

The present invention will now be illustrated more in details by the following example.

### EXAMPLE

The following aqueous insecticide was prepared and packaged under pressure together with a usual propellant (LPG):

### 1 Compounds wt % Natural Pyrethrins 0.50 Malathion 1.00 Piperonyl Butoxide 0.20 Boric Acid 1.00 Sodium Benzoate 0.50 Isopropyl Alcohol 2.00 Sorbitan Monooleate 0.50 4-Nitrophenol 0.10 Water 39.20 Propellant (LPG) 55.00 TO TOTAL 100.00

This composition of a pH of about 7.0 and of a yellow colour was applied by spraying to various kinds of surfaces, such as wood, painted wood, painted walls, ceramic tile, plastic (polyethylene), glass and stainless steel.

After about 40 minutes of exposure to air (including carbon dioxide), the composition was dried and the yellow colour disappeared.

The insecticide activity was tested and found in agreement with the usual requirements of similar composition.

Other levels of 4-nitrophenol were tested, and it was shown that with 0.05 wt % the yellow colour was somewhat faint but with a shorter colour changing time (about 25 min.), whereas with highest content, i.e. 0.5 resp. 1.0%, the colour change takes more time, i.e. 70 resp. 120 min.

Phenolphthalein was also tested at levels of 0.01 to 1.0 wt %, which all gave acceptable results and a colour change of about 40 min. The pH of the composition was initially adjusted to 9.4 using triethanolamine.

The method according to the present invention was then further experimented, in that areas of the surfaces treated by the insecticide composition were remoistened, for example by simply spraying tap water (pH-7.5-8.5) thereon. It was thus confirmed that the remoistened areas become again yellow (respectively pink-red with phenolphthalein), so that it was possible to control the presence or the absence of the insecticide composition thereon.

What is claimed is:

1. Insecticide composition comprising at least one insect killing agent in aqueous solution and a temporary non-persistent color indicator in the form of a pH indicator that changes to colorless after about 40 minutes of exposure of the insecticide composition to air.

2. Insecticide composition according to claim 11, wherein the temporary non-persistent color indicator is a pH indicator selected from the group of 3-nitrophenol, 4-nitrophenol, phenolphthalein, and thymolphthalein.

3. Insecticide composition according to claim 12, wherein the pH indicator is of 0.01 to 1.0 wt %.

4. Insecticide composition according to claim 12, wherein the pH indicator is of 0.05 to 0.5 wt %.

5. Insecticide composition according to claim 12, wherein the insect killing agent is selected from the group of n-pyrethrins, malathion, boric acid, tetramethrin, esbiothrin, Etoc, neopynamineforte, deltamethrin, propoxur, cypermethrin, and Gokilaht S.

6. Insecticide composition according to claim 15, wherein the pH indicator is of 0.01 to 1.0 wt %.

7. Insecticide composition according to claim 15, wherein the pH indicator is of 0.05 to 0.5 wt %.

8. Insecticide composition according to claim 12, wherein the insect killing agent is at a level of 0.01 to 1.0 wt %.

9. Insecticide composition according to claim 13, wherein the insect killing agent is at a level of 0.01 to 1.0 wt %.

10. Insecticide composition according to claim 14, wherein the insect killing agent is at a level of 0.01 to 1.0 wt %.

11. Insecticide composition according to claim 15, wherein the insect killing agent is at a level of 0.01 to 1.0 wt %.

12. Insecticide composition according to claim 16, wherein the insect killing agent is at a level of 0.01 to 1.0 wt %.

13. Insecticide composition according to claim 17, wherein the insect killing agent is at a level of 0.01 to 1.0 wt %.

14. Insecticide composition according to claim 11, wherein the composition comprises the following compounds in substantially the following amounts:

| Compounds | wt % |
|---|---|
| Natural Pyrethrins | 0.5 |
| Malathion | 1.0 |
| Piperonyl Butoxide | 0.2 |
| Boric Acid | 1.0 |
| Sodium Benzoate | 0.5 |
| Isopropyl Alcohol | 2.0 |
| Sorbitan Monooleate | 0.5 |
| 4-Nitrophenol | 0.1 |
| Water | 39.2 |
| Propellant (LPG) | 55.0 |
